(19) United States
(12) Patent Application Publication
(10) Pub. No.: US 2004/0233845 A1
(43) Pub. Date: Nov. 25, 2004

(54) Buffer management-based real-time and data integrated transmission in UDP/TCP/IP-based networks

(76) Inventors: Seong-ho Jeong, Yongin-si (KR); Jong-ho Bang, Suwon-si (KR); Se-jong Oh, Anyang-si (KR); Ji-hoon Lee, Cheongin-si (KR); Sung-hyuck Lee, Daegu (KR)

Correspondence Address: LEE & STERBA, P.C., Suite 2000, 1101 Wilson Boulevard, Arlington, VA, 22209, US

(21) Appl. No.: 10/839,180

(22) Filed: May 6, 2004

Related U.S. Application Data
(60) Provisional application No. 60/468,992, filed on May 9, 2003.

(30) Foreign Application Priority Data
Jun. 4, 2003 (KR) 2003-35915

(51) Int. Cl. H04J 3/22

(52) U.S. Cl. 370/230; 370/235; 370/412

(57) ABSTRACT

In an edge router controlling traffic flows using a buffer in a network handling both real-time traffic and data application traffic, a buffer management-based transmission includes receiving a packet from the network and deciding whether the received packet is a choke packet. If the received packet is not the choke packet, then the received packet is classified into a predetermined traffic class. The buffer is divided logically, and a buffer area of the logically divided buffer is assigned to the traffic class into which the received packet is classified. Control of transmission of the received packet includes either dropping the received packet or storing the received packet in the buffer area assigned to the classified traffic class. Accordingly, the present invention can continuously guarantee appropriate bandwidth required for real-time traffic and, at the same time, prevent a situation in which no bandwidth is assigned to data application traffic.

### BACKGROUND OF THE INVENTION

1. Field of the Invention

The present invention relates to integrated transmission of real-time traffic, e.g., audio/video, and data traffic in UDP-, TCP-, and IP-based internet-core networks. More particularly, the present invention is directed to integrated transmission based on an efficient and easy-to-implement buffer management scheme designed in accordance with real-time traffic and data traffic characteristics and required Quality of Service (QoS).

2. Description of the Related Art

Transmission Control Protocol (TCP) and User Datagram Protocol (UDP) are both transport layer protocols of the Open System Interconnection (OSI) layer structure. Both use the Internet Protocol (IP) as the network layer protocol of the OSI layer structure. However, the TCP and the UDP are different in many ways. One such difference is that the TCP provides a flow control, but the UDP does not. However, the UDP is simpler and faster than the TCP. Thus, the UDP is used as the transport layer for real-time applications, such as audio and/or video transmissions.

The TCP flow control recognizes network congestion by detecting packet loss. The TCP flow control then reduces its output rate to avoid further congestion. However, the UDP carrying real-time application traffic, such as video or audio, has no flow control. Thus, the UDP does not control the traffic transmission rate even when network congestion occurs. In other words, the UDP does not control the transmission rate while the TCP does. Since the UDP traffic travels at higher speeds than the TCP traffic, this operational difference can result in UDP traffic entirely consuming network resources, such as bandwidth and buffers. This results in no resources being allotted for the TCP traffic.

Once the UDP traffic utilizes all the network resources, the QoS cannot be guaranteed for TCP application traffic. Therefore, a method for continuously guaranteeing appropriate bandwidth necessary for real-time traffic, while ensuring some network resources are assigned for TCP-based data application traffic, is needed.

Currently, the QoS required in a network is achieved with scheduling schemes and buffer management schemes. The scheduling schemes can precisely control bandwidth using multiple buffers. However, the scheduling schemes are difficult to implement at a high speed due to the complicated algorithms employed. These algorithms only become more complex as the number of users increases.

The buffer management schemes have a relatively simple structure, since they control traffic using a single buffer. The simplest buffer management scheme employs a tail drop algorithm, which uses a First-In First-Out (FIFO) buffer in the existing router providing Best-Effort Service (BES) only. The tail drop algorithm uses one FIFO buffer to control flow of all packets received by the router. If the router receives a packet when the FIFO buffer is full, the received packet is instantly dropped.

Accordingly, when packets transported at a high speed, typically the UDP packets, have completely filled the FIFO buffer and the router receives packets transported at a low speed, typically TCP packets, all the packets transported at a low speed may be dropped since the FIFO buffer is full.

Further, if the FIFO buffer is full, the waiting time of packets stored in the FIFO buffer increases, so that the QoS can be degraded even for real-time applications.

In order to solve problems arising from use of the tail drop algorithm, the rate for packets to occupy the FIFO buffer may be arbitrarily reduced, i.e., the number of packets stored in the buffer is dropped. However, such an arbitrary packet drop can result in unnecessarily and frequently dropped packets. If packets are dropped, the TCP implements congestion controls and continuously reduces transmission speed in proportion to the packet drop rate. Thus, this arbitrary dropping will still not result in appropriate network resources being assigned for TCP-based applications.

Further, in order to solve problems arising from use of the tail drop algorithm, diverse mechanisms have been proposed, such as Random Early Detection (RED), Flow Random Early Drop (FRED), Stabilized RED (SRED), Deficit Round Robin (DRR), and Core-Stateless Fair Queuing (CSFQ). However, such mechanisms do not take into consideration the QoS requirements of both UDP-based real-time applications, such as voice communications, and TCP-based applications, such as data traffic.

### SUMMARY OF THE INVENTION

The present invention is therefore directed to integrated transmission of real-time applications and data applications that substantially overcomes one or more of the problems due to the limitations and disadvantages of the related art.

It is a feature of the present invention to provide a voice and data integrated transmission that considers both real-time and data traffic characteristics and required Quality of Service (QoS) of the UDP-, TCP-, and IP-based internet-core networks. It is another feature of the present invention to provide real-time and data integrated transmission that is efficient. It is yet another feature of the present invention to provide real-time and data integrated transmission as an easy-to-implement buffer management scheme.

At least one of the above and other features and advantages may be realized by providing a buffer management-based transmission method in an edge router for a network transmitting different predetermined traffic classes. The edge router controls traffic flow using a buffer. The method includes receiving a packet from the network, deciding whether the received packet is a choke packet signifying traffic congestion of the network. If the received packet is not the choke packet, the method includes classifying the received packet into a predetermined traffic class, dividing the buffer logically, assigning a buffer area of the logically divided buffer to the traffic class into which the received packet is classified, determining whether any capacity remains in the buffer area assigned to the traffic class, and controlling transmission of the received packet either by dropping the received packet or by storing the received packet in the buffer area assigned to the classified traffic class.

Classifying the received data may include classifying the received packet into a first traffic class if the received packet is an UDP packet, into a second traffic class if the received packet is a TCP packet, and into a third traffic class if the received packet is not the UDP packet or TCP packet. Assigning the buffer area may include assigning a first buffer area to the first traffic class, the first buffer area having a size corresponding to a predetermined threshold value, and assigning a second buffer area to the second and third traffic classes.

Controlling transmission may include dropping the received packet if the received packet is the first traffic class and a total number of packets previously stored in the first buffer area is larger than the predetermined threshold value. Controlling transmission may include dropping the received packet if the received packet is not the first traffic class and a total number of packets previously stored in the second buffer area is larger than a difference between an entire capacity of the buffer and the predetermined threshold value.

Classifying the received packet may include classifying the received packet into the predetermined traffic class using a Type of Service (ToS) field and a protocol identification (ID) field of the received packet. The method may further include modifying a traffic profile stored in the edge router and controlling traffic flowing into the network, if the received packet is the choke packet.

Classifying the received data may include classifying the received packet into a first traffic class if the received packet is a real-time packet and into a second traffic class otherwise. Assigning the buffer area may include assigning a first buffer area to the first traffic class, the first buffer area having a size corresponding to a predetermined threshold value, and assigning a second buffer area to the second traffic class.

At least one of the above and other features and advantages may be realized by providing a network transmitting both User Datagram Protocol (UDP) packets and Transmission Control Protocol (TCP) packets, including a plurality of hosts, a core network, and an edge router including a buffer. The edge router is between at least one of the plurality of hosts and the core network. The buffer is logically divided into at least a first and second region. The first region stores only UDP packets and has a predetermined size. The second region stores only non-UDP packets, including TCP packets.

### BRIEF DESCRIPTION OF THE DRAWINGS

The above and other features and advantages of the present invention will become readily apparent to those of skill in the art by describing in detail embodiments thereof with reference to the attached drawings, in which:

FIG. 1 is a schematic illustration of a network environment to which a voice and data integrated transmission according to an embodiment of the present invention is applied;

FIG. 2 is an illustration explaining classification of traffic into three classes in an edge router according to an embodiment of the present invention;

FIG. 3 is a block diagram of a logically divided buffer based on three traffic classes classified in the edge router according to an embodiment of the present invention; and

FIG. 4 is a flow chart illustrating a buffer management-based method for integrated transmission of real-time and data applications in the edge router according to an embodiment of the present invention.

### DETAILED DESCRIPTION OF THE INVENTION

U.S. Provisional Application No. 60/468,992, filed on May 9, 2003, in the U.S. Patent & Trademark Office, entitled: “Buffer Management-Based Voice and Data Integration Transmission Method in UDP/TCP/IP-Based Networks;” and Korean Patent Application No. 2003-35915, filed on Jun. 4, 2003, in the Korean Intellectual Property Office, entitled: “Method for Voice/Data Transport Over UDP/TCP/IP Networks Using an Efficient Buffer Management,” are both incorporated herein by reference in their entirety.

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art.

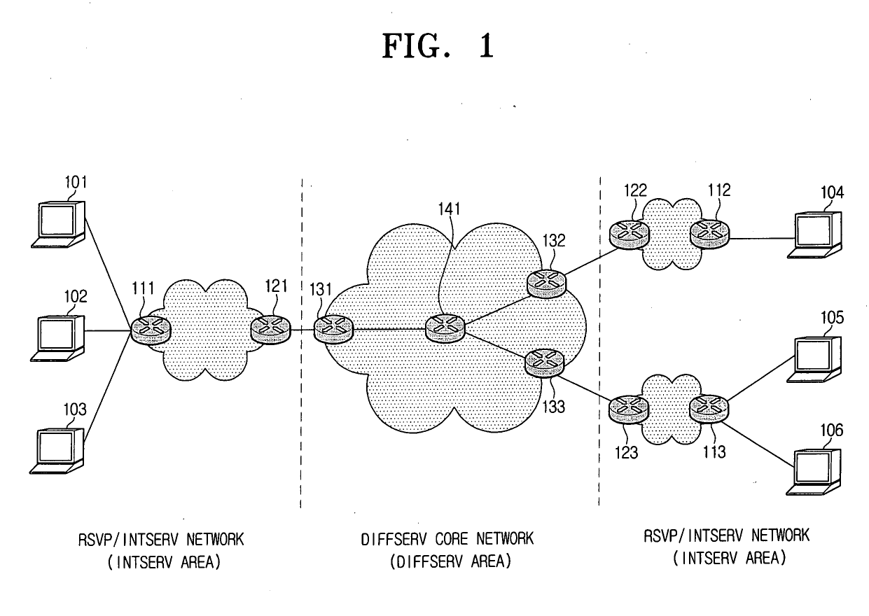

FIG. 1 schematically illustrates a network environment utilizing a real-time, e.g., audio and/or video, and data integrated transmission according to an embodiment of the present invention. Referring to FIG. 1, a network includes hosts 101, 102, 103, 104, 105, and 106; leaf routers 111, 112, and 113; edge routers 121, 122, and 123; border routers 131, 132, and 133; and a core router 141.

In FIG. 1, peripheral, i.e., left and right, areas of the three areas divided by the dashed lines each denote a local network, to which Integrated Service (Intserv) is provided. The Intserv provides the Controlled Load Service and the Guaranteed Service, which require enhanced performance and reliability as compared to the Best-Effort Service.

The middle area of the three areas divided by the dashed lines of FIG. 1 denotes a core network, to which Differentiated Service (Diffserv) is provided. The Diffserv mechanism treats packets based on the bits in the Type of Service (ToS) field and the protocol identification (ID) field of the IP header of a packet to produce a differentiated service class, which is based on relative priority among the packets.

The hosts 101, 102, 103, 104, 105, and 106 transport data packets based on QoS applications and the Reservation Protocol (RSVP). The edge routers 121, 122, and 123 control traffic through per-flow based control and a traffic profile for each flow.

Further, the edge routers 121, 122, and 123 send and receive a QoS Request and a QoS Response, respectively, to reserve resources in the core network. The core router 141 receives and sends the QoS Request and the QoS Response, respectively. In particular, the core router 141 compares the capacity of available network resources with a requested QoS, and admits or rejects the requested QoS. Accordingly, the core router 141 does not have to store a per-flow state.

However, the core router 141 maintains two variables, the aggregate acceptance rate R_{ac} and the aggregate arrival rate Rₐᵣ. The aggregate acceptance rate R_{ac} is periodically updated to the largest value based on a predetermined time interval. Further, the aggregate arrival rate Rₐᵣ is updated based on Equation (1) as follows:

R_{ar,N}=(1−e^{-T/K})l/T+e^{-T/K}R_{ar,P} (1)

where “I” is an arrival packet size, “T” is a packet arrival time, “K” is a predetermined constant, “R_{ar,N}” is a new aggregate arrival rate“, and “R_{ar,P}” is a previous aggregate arrival rate.

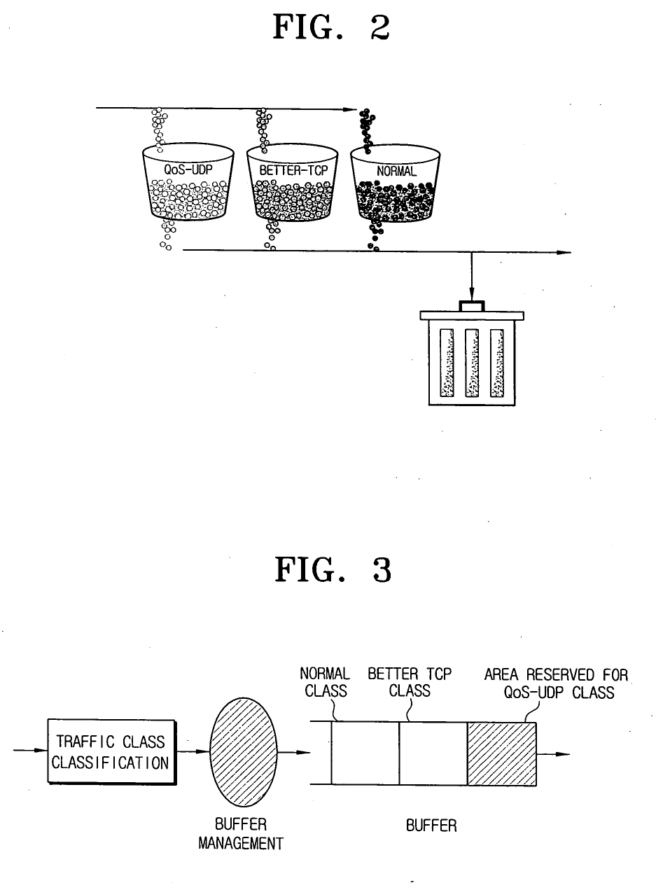

FIG. 2 illustrates classification of traffic into three classes in an edge router according to an embodiment of the present invention. As shown in FIG. 2, UDP-compliant real-time traffic, such as audio or video, is classified into a QoS-UDP class so that-appropriate bandwidth is preferentially supported. TCP-compliant data traffic is classified into a Better-TCP class, thereby assigning some bandwidth for the traffic and preventing no bandwidth from being assigned, as noted above in connection with the related art. Any other traffic is classified into a Normal class, and is not treated in any particular manner.

FIG. 3 illustrates a logically divided buffer based on the three traffic classes in an edge router according to an embodiment of the present invention. Hereinafter, referring to FIG. 3, explanations will be made on services capable of supporting the respective traffic classes.

Different services are defined for traffic associated with the three traffic classes. In particular, the services correspond to the classes as follows: Rate Guarantee Service (RGS) for the QoS-UDP class, Better-then-Best-Effort Service (BBES) for the Better-TCP class, and Best Effort Service (BES) or Less-than-Best-Effort Service (LBES) for the Normal class. A buffer in an edge router is apportioned in accordance with the traffic characteristics by class, so that corresponding services are provided.

In order to implement services by traffic class, the buffer in the edge router is logically divided and assigned to the respective classes, as shown in FIG. 3. In order to continuously ensure appropriate bandwidth required for real-time traffic of the QoS-UDP class, a fixed size having a threshold value Qₜₕ of the buffer area is preferentially reserved and assigned, so that logical buffer division and management are accomplished. Further, the remaining buffer area not reserved for the QoS-UDP class is appropriately assigned to traffic belonging to the other classes in accordance with their respective traffic situations. As shown in FIG. 3, the Better-TCP class is given precedence over the Normal class.

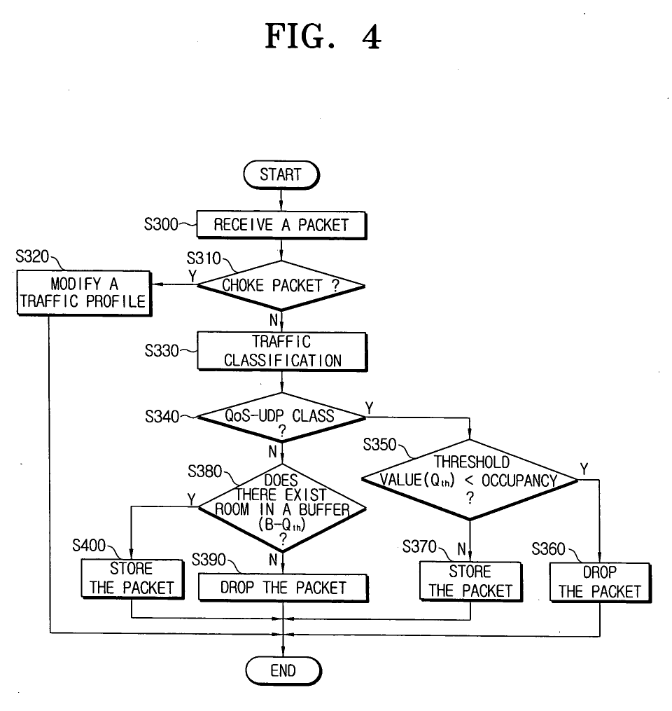

FIG. 4 is a flow chart showing a buffer management-based voice and data integration transmission method in an edge router according to an embodiment of the present invention. Hereinafter, with reference to FIG. 4, a detailed description of a process for assigning buffer areas and transmitting packets in the edge router to implement services for the respective traffic classes is provided.

When a packet arrives in the edge router (S300), the edge router first decides whether the packet is a choke packet or a general application packet (S310). Choke packets are packets sent to the edge router of a source in order to notify the source of congestion situations when traffic congestion occurs in a network after the edge router sends packets to the network packets. The choke packet may be an Internet Control Message Protocol (ICMP) source quench message. When choke packets are received, the edge router controls a transmission rate of traffic flowing into the network to alleviate congestion.

Accordingly, if the received packet is a choke packet, the edge router modifies the profile of traffic flowing into the network (S320) until the congestion is resolved. To do this, the edge router configures traffic profiles, such as a per-flow traffic profile, by flow for each traffic class. For example, a manifest traffic profile may be configured for the QoS-UDP class and an estimate traffic profile may be configured for the Better-TCP class.

The edge router periodically sends one choke packet every N data packets. Such a choke packet is small and includes a mark enabling the edge router that is the source to be identified. If an estimated transmission rate of each flow is “rₑ”, the transmission rate of the choke packet is “rₑ/N”.

The traffic profile is controlled by the edge router based on Equation (2) as follows:

$${r}_{e}^{i} = ( \begin{matrix}{r}_{e}^{i} + α , if {n}_{i} = 0 \\ max \{ 0 , {r}_{e}^{i} - β {n}_{i} \} , if {n}_{i} > 0\end{matrix} ) \qquad ( 2 )$$

where “rₑⁱ” is an estimated transmission rate as to flow “i,” “α” is a transmission rate increment value, “β” is a transmission rate decrement value, and “nᵢ” is the number of choke packets received for the flow “i.”

In the meantime, if the received packet is a general application packet, a corresponding traffic class of the received packet is determined using the ToS fields and protocol ID field of the IP header of the received packet (S330). The UDP packets of real-time traffic are classified as the QoS-UDP class, the TCP packets of data traffic are classified as the Better-TCP class, and any other traffic is classified as the Normal class.

Next, it is decided whether the received packet belongs to the QoS-UDP class (S340). This determination is for providing the RGS defined for the packets belonging to the QoS-UDP class, thereby ensuring the QoS required for real-time applications.

If the received packet belongs to the QoS-UDP class, the threshold value “Qₜₕ” of the logical buffer area assigned to the QoS-UDP class is compared with a current occupancy of the logical buffer area assigned to the QoS-UDP class (S350). If the current occupancy amount exceeds the threshold value Qₜₕ, the edge router drops the received packet (S360). Otherwise, the edge router stores the received packet in the logical buffer area assigned to the QoS-UDP class (S370).

In the meantime, if the received packet does not belong to the QoS-UDP class, the edge router decides whether the logical buffer area has sufficient capacity, i.e., if a difference between the entire buffer size (B) and the threshold value Qₜₕ of the logical buffer area assigned to the QoS-UDP class is greater than zero (S380). If there is no available capacity in the remaining buffer area except for the logical buffer area assigned to the QoS-UDP class, the edge router drops the received packet (S390). Otherwise, the edge router stores the received packet (S400).

The present invention classifies real-time and data traffic into the QoS-UDP class, Better-TCP class, and Normal class in the UDP-, TCP-, and IP-based internet core network, and logically divides and manages one buffer of the edge router by traffic class in order to provide differentiated services based on the respective traffic classes.

Accordingly, the present invention can continuously guarantee appropriate bandwidth required for real-time traffic and, at the same time, prevent the situations in which no bandwidth is assigned for TCP-based data application traffic.

Further, the present invention enables efficient and easy-to-implement buffer management that enables integration of transmission of real-time and data in accordance with respective traffic characteristics and required QoS.

Embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A buffer management-based transmission method in an edge router for a network transmitting different predetermined traffic classes, the edge router controlling traffic flow using a buffer, the method comprising:
receiving a packet from the network;
deciding whether the received packet is a choke packet signifying traffic congestion of the network;
classifying the received packet into a predetermined traffic class, if the received packet is not the choke packet;
dividing the buffer logically;
assigning a buffer area of the logically divided buffer to the traffic class into which the received packet is classified;
determining whether any capacity remains in the buffer area assigned to the traffic class; and
controlling transmission of the received packet either by dropping the received packet or by storing the received packet in the buffer area assigned to the classified traffic class.

2. The buffer management-based transmission method as claimed in claim 1, wherein classifying the received data further comprises classifying the received packet into a first traffic class if the received packet is an UDP packet, into a second traffic class if the received packet is a TCP packet, and into a third traffic class if the received packet is not the UDP packet or TCP packet.

3. The buffer management-based transmission method as claimed in claim 2, wherein assigning the buffer area comprises:
assigning a first buffer area to the first traffic class, the first buffer area having a size corresponding to a predetermined threshold value; and
assigning a second buffer area to the second and third traffic classes.

4. The buffer management-based transmission method as claimed in claim 3, wherein controlling transmission comprises dropping the received packet if the received packet is the first traffic class and a total number of packets previously stored in the first buffer area is larger than the predetermined threshold value.

5. The buffer management-based transmission method as claimed in claim 3, wherein controlling transmission comprises dropping the received packet if the received packet is not the first traffic class and a total number of packets previously stored in the second buffer area is larger than a difference between an entire capacity of the buffer and the predetermined threshold value.

6. The buffer management-based transmission method as claimed in claim 1, wherein classifying the received packet comprises classifying the received packet into the predetermined traffic class using a Type of Service (ToS) field and a protocol identification (ID) field of the received packet.

7. The buffer management-based transmission method as claimed in claim 1, further comprising modifying a traffic profile stored in the edge router and controlling traffic flowing into the network, if the received packet is the choke packet.

8. The buffer management-based transmission method as claimed in claim 1, wherein classifying the received data further comprises classifying the received packet into a first traffic class if the received packet is a real-time packet and into a second traffic class otherwise.

9. The buffer management-based transmission method as claimed in claim 8, wherein assigning the buffer area comprises assigning a first buffer area to the first traffic class, the first buffer area having a size corresponding to a predetermined threshold value, and assigning a second buffer area to the second traffic class.

10. A network transmitting both User Datagram Protocol (UDP) packets and Transmission Control Protocol (TCP) packets, comprising:
a plurality of hosts;
a core network; and
an edge router including a buffer, the edge router being between at least one of the plurality of hosts and the core network, the buffer being logically divided into at least a first region and a second region, the first region for storing only UDP packets and having a predetermined size, the second region for storing only non-UDP packets, including TCP packets.
